(19) United States
(12) Patent Application Publication
(10) Pub. No.: US 2006/0079236 A1
(43) Pub. Date: Apr. 13, 2006

(54) Pseudo number portability in fixed-mobile convergence with one number

(75) Inventors: Felipe Alvarez Del Pino, Sunrise, FL (US); Ercan Sen, Lake Worth, FL (US); Chenghui Wang, West Palm Beach, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/231,436

(22) Filed: Sep. 20, 2005

Related U.S. Application Data
(60) Provisional application No. 60/612,107, filed on Sep. 22, 2004.

(51) Int. Cl. H04Q 7/20

(52) U.S. Cl. 455/445

(57) ABSTRACT

A Fixed-Mobile Convergence (FMC) network and method of handling calls in a FMC network. Registration is maintained for FMC User Equipment (UE) with at least two (a primary and a secondary) networks, e.g., a mobile network and a fixed network with a wireless connection capability. The primary network maintains subscribers numbers with each FMC UE being assigned one of the subscribers numbers. Calls to FMC UE are routed to the primary network and, if the UE is not present in the primary network, forwarded to the secondary network. A preferred FMC network may be implemented in existing fixed and mobile networks without requiring that one be integrated into the other.

### CROSS REFERENCE TO RELATED APPLICATION

The present invention claims priority from U.S. Provisional Patent Application Ser. No. 60/612,107, entitled “Pseudo Number Portability in Fixed-Mobile Convergence with One Number” to Felipe Alvarez Del Pino et al., filed Sep. 22, 2004, the content of which is incorporated herein by reference.

### BACKGROUND OF THE INVENTION

1. Field of the Invention

The present invention is related to communication systems and, more particularly, to Fixed-Mobile Convergence (FMC) and maintaining communications while roaming between communication networks.

2. Background Description

Dual mode handsets are well known for connecting wirelessly to conventional GSM/CDMA mobile services and to a data network, e.g., WiFi. These types of dual mode devices have facilitated a new area of technology that is known as Fixed-Mobile Convergence (FMC). It is intended that FMC subscribers with a dual mode handset (User Equipment or UE) can roam between the two network types, one a fixed network and the other a mobile network. Simple approaches to modifying existing networks require two numbers, with either or both numbers being public numbers, or with one public number and one hidden number. Ideally, however, each FMC network subscriber has a single common directory number (number or DN) for both networks. There are different known methods to implement the roaming feature (i.e., allowing a subscriber to roam between two different types of network) in an FMC environment with one number.

One approach involves modifying the mobile network to integrate the fixed network into the mobile network with an interface from the fixed network to the mobile network. The interface treats the fixed network as a radio access network (RAN) for the mobile network. Although this approach impacts the fixed network, impact to the mobile network can be avoided using concepts from the Unlicensed Mobile Access Consortium (UMAC) and Third Generation Partnership Project (3GPP). Another approach is to integrate the fixed network into the mobile network by treating the fixed network as a Core Network (CN) extension of the mobile network, e.g., providing a Mobile services Switching Center (MSC) interface to the mobile network. Both of these approaches locate FMC subscribers with the location management function in the existing mobile network, and both require integrating the fixed network into the mobile.

Unfortunately, even when the same vendor/service provider owns both networks, integrating the fixed network into the mobile network is difficult, time consuming, expensive and requires a complicated architecture. While it may be difficult to build such an integrated network from scratch, it is especially troublesome, impractical and may be impossible to integrating pre-existing and incompatible fixed and mobile networks which were not originally designed with easy integration in mind.

Thus, there is a need for a Fixed-Mobile Convergence (FMC) communications system that does not require integrated fixed and mobile networks and more particularly, for a FMC system with FMC subscribers having a single assigned number in both a distinct fixed network and a distinct mobile network.

### SUMMARY OF THE INVENTION

It is therefore a purpose of the invention to simplify roaming between two different types of networks regardless of network type for each;

It is another purpose of the invention to allow user equipment to maintain a communications connection through a distinct fixed network or a distinct mobile network;

It is yet another purpose of the invention to facilitate effectively and efficiently providing single number access to subscribers, whether the subscriber is being accessed through a distinct fixed network or a distinct mobile network;

It is yet another purpose of the invention to facilitate single number Fixed-Mobile Convergence (FMC) for freely roaming between an existing fixed network and an existing mobile network without impact to the existing mobile network or the existing fixed network;

It is yet another purpose of the invention to simplify the roaming feature in the convergence of two different types of networks regardless of network type.

The present invention is related to Fixed-Mobile Convergence (FMC) and, in particular, a FMC network and method of handling calls in the FMC network. Registration is maintained for FMC User Equipment (UE) with at least two (a primary and a secondary) networks, e.g., a mobile network and a fixed network with a wireless connection capability. The primary network maintains subscribers numbers with each FMC UE being assigned one of the subscribers numbers. Calls to FMC UE are routed to the primary network and, if the UE is not present in the primary network, forwarded to the secondary network. A preferred FMC network may be implemented in existing fixed and mobile networks without requiring that one be integrated into the other.

According to one preferred embodiment of the invention, a directory number (DN) of a FMC subscriber is allocated from a pool that was originally assigned to, and is still owned by, the fixed network operator. In this sense the fixed network may be considered the subscriber's primary home network. The subscriber number is provisioned in both the fixed and the mobile networks registers, and therefore the subscriber's DN can be a Mobile Station International ISDN Number (MSISDN) for GSM or UMTS or a Mobile Directory Number (MDN) for CDMA or TDMA as well. Furthermore, according to a preferred embodiment the DN is not provisioned in any public Number Portability Database (NPDB), but instead is provisioned in the fixed network's internal special routing table that may be considered analogous to an internal NPDB. The table contains blocks of the subscriber numbers corresponding to each Location Routing Number (LRN) owned by the mobile network (referred to hereafter as the subscriber's HPLMN). The mobile network HPLMN may be considered the subscriber's secondary home network. The ownership of the subscriber number ensures that a terminating call to a FMC subscriber is routed to the fixed network.

Also according to a preferred embodiment, a new application is introduced in the fixed network's existing application server. Upon an incoming call (which in a preferred embodiment may be received from either outside or inside of the fixed network), this new application determines the subscriber's current status. If the subscriber is available in the fixed network, the call is processed and terminated to the user equipment (UE) in the fixed network. Otherwise, if the subscriber is roaming in the mobile network, e.g. the subscriber is unavailable in the fixed network, the call is routed to the subscriber's HPLMN using the LRN returned from the internal special routing table query, which may use a method analogous to a number portability method. As an example, the method used can be analogous to the method of Number Portability described in American National Standard (ANS) T1.708-1998 (R2003), entitled “PCS 1900 Service Provider Number Portability”. Thus, the DN may be viewed as being temporarily and conditionally ported out to the HPLMN as a MSISDN. In a preferred embodiment of this invention, the directory number of the subscriber that was originally used for the call can also be conveyed to the fixed network, along with the LRN, to help identify the subscriber in the fixed network. In the case that the method is based on the method of ANS T1.708-1998 (R2003), the original directory number can be conveyed in an ISUP Generic Parameter.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of FMC network architecture according to a preferred embodiment of the present invention;

FIG. 2 shows an example of a call flow for a MT Call to a FMC subscriber in a Home IMS Network according to a preferred embodiment of the present invention;

FIG. 3 shows an example of a call flow for a MT Call to a FMC subscriber roaming in a GSM Network according to a preferred embodiment of the present invention.

### DESCRIPTION OF PREFERRED EMBODIMENTS

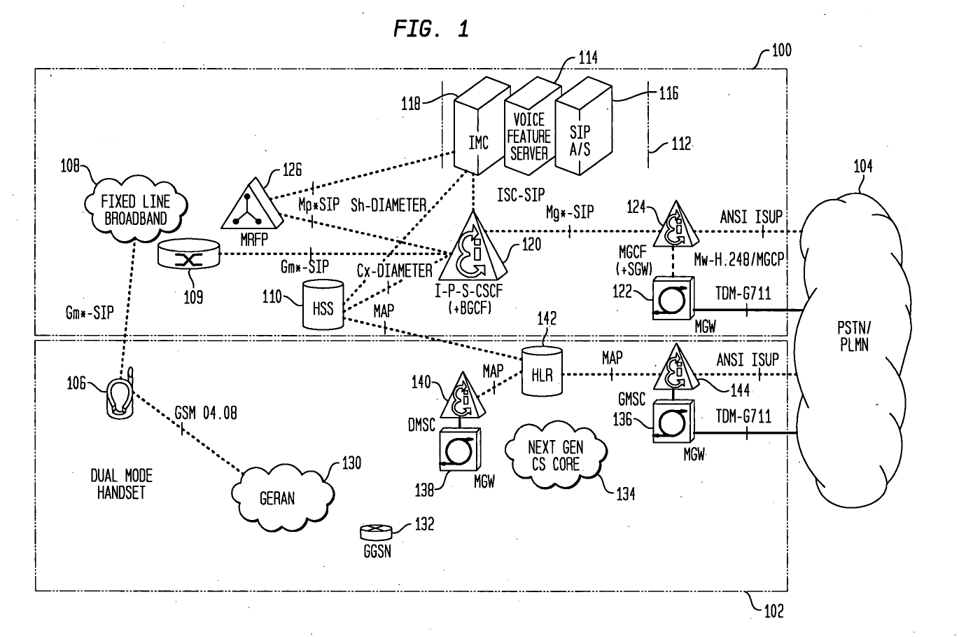

Turning now to the drawings and, more particularly, FIG. 1 shows an example of a preferred embodiment Fixed-Mobile Convergence (FMC) communications network according to the present invention. In a preferred FMC communications network suitably equipped subscribers are each assigned a single Directory Number (DN) for seamlessly connecting while roaming between the networks, e.g., a fixed network 100 and a mobile network 102. The fixed network 100 includes a wireless capability that may be, for example, a part of a product bundle with broadband service that includes IEEE 802.11b (WiFi) with Voice over Internet Protocol (VoIP), or WiFi/VoIP, over Asymmetric Digital Subscriber Line (ADSL). The fixed network 100 and mobile network 102 are linked to each other over a Public Switched Telephone Network (PSTN)/Home Public Land Mobile Network (HPLMN) 104. Preferably, the fixed network 100 is located within the coverage of the mobile network 102 for seamless operation. Subscribers have User Equipment (UE) 106 with an assigned pseudo-number. The UE 106 seamlessly connects to the mobile network 102, whenever the UE 106 is unable to connect to the fixed network 100; and seamlessly reconnects to the fixed network 100 as the UE 106 is able with calls to the respective pseudo-number routed appropriately.

The default connection is through the FMC subscriber's primary home network, preferably, the fixed network 100. The fixed network 100 has a pool of pseudo-numbers in dedicated blocks of the subscriber numbers. Each FMC subscriber has a pseudo-number that is allocated from the pool. Initially, calls to FMC subscriber pseudo-numbers are routed to the fixed network 100, including mobile originated (MO) calls originating from the mobile network 102. The home network routes calls directed to a pseudo-number to the mobile network 102 whenever the particular UE 106 is unavailable in the fixed network 100.

So, the fixed network 100 includes some wireless connection capability to a fixed line broadband 108, e.g., through IEEE 802.11b (WLAN or WiFi) or a Bluetooth connection. For example, the fixed network 100 may be in a home with a residential gateway that includes an integrated ADSL modem to the fixed line broadband 108. A router 109 connects the fixed line broadband 108 to an integrated WiFi base station as part of a typical Internet Protocol (IP) Multimedia (IM) Subsystem or IMS bundle. The IMS, in turn, interfaces multimedia information (e.g., voice and data) to the public network, PSTN/PLMN 104.

The IMS application layer includes a Home Subscriber Server (HSS) 110 and Application Servers (AS) 112. The Application Servers 112 include, for example, a voice feature server 114, a Session Initiation Protocol (SIP) AS (SIP-AS) 116, and an Internet Mail Consortium (IMC) server 118. The SIP-AS 116 interfaces to the HSS 110 through a Dx Diameter protocol interface to provide intelligent services/applications to the IMS network. Also in this example, the Application Servers 112 interface to the IMS session control layer over an IMS Service Control (ISC) SIP (ISC-SIP) interface.

The IMS session control layer includes Call Session Control Function (CSCF) 120. The CSCF 120 includes: a Proxy CSCF (P-CSCF) providing each UE 106 with an entry point to the IMS; an Interrogating CSCF (I-CSCF) interfaced to the HSS 110 through a Cx Diameter protocol interface; and, a Serving CSCF (S-CSCF) as a session control entity for the IMS handling UE 106 registration and also interfaced to the HSS 110 through the Cx Diameter protocol interface. Also, a Breakout Gateway Control Function (BGCF) may coexist with the CSCF 120 or as a stand alone module. The BGCF selectively passes calls to the PSTN/PLMN 104 through a Media Gateway (MGW) 122 under control of Media Gateway Control Function (MGCF) 124. So, the IMS network interfaces to the PSTN/PLMN 104 with a Signaling GateWay (SGW) in the MGCF 124 interfacing the signaling plane, and the MGW 122 interfacing the media plane. A Multimedia Resource Function Processor (MRFP) 126 can implement call treatment and media-related functions. The MRFP 126 interfaces with the AS 112 and the CSCF 120 through a Multi-Point SIP (MP SIP) interface.

The HSS 110 acts as the subscriber register for the IMS network within the fixed network 100, while the HLR 142 acts as the subscriber register in the mobile (e.g. GSM) network 102, e.g., provisioning FMC subscriber numbers. In the mobile network 102, the HLR 142 provisions subscriber numbers as Mobile Station International ISDN Numbers (MSISDNs). The HSS 110 interfaces with the HLR 142, e.g., through an optional Mobile Application Part (MAP) interface. Alternately, the HSS 110 may act as a sole subscriber register for both the fixed network 100 and the mobile network 102, provided the HSS has sufficient capability. Optionally, the IMS network connects to the RAN 130 through the GGSN 132. Also, preferably, dual mode handset UEs 106 remain connected to the CSCF 120 through the RAN 130, even roaming in the mobile network 102.

Preferably, system numbers (DNs and/or MSISDNs) are not provisioned in public Number Portability Databases (NPDBs). Instead, an internal special routing table (not shown) in the HSS 110 provisions system numbers. This special routing table contains the pseudo-numbers in blocks of subscriber numbers corresponding to each LRN. The HPLMN for each subscriber within the mobile network owns the LRN for the subscriber and ports the numbers to the fixed network 100 as described in more detail hereinbelow. So, the HPLMN acts as the subscribers' secondary home network for the converged networks 100, 102. Also, the special routing table simulates standard number portability for routing calls to subscriber UEs 106 that are found in the fixed network 100; and when a subscriber UE 106 is not available in the fixed network 100, using the LRN to route calls to the mobile network 102. An example of suitable standard number portability is described in American National Standard (ANS) T1.708-1998 (R2003), entitled “PCS 1900 Service Provider Number Portability.”

The SIP-AS 116 is a very flexible and dynamic network element that may either reside in the user's home network or in a third party network location. In particular, including the SIP-AS 116 in the fixed network makes value added IMS services available to the fixed network 100 and greatly improves efficiency for new feature development, services development, and application development. So, preferably, the SIP-AS 116 is a feature server for the fixed network 100, which routes incoming calls to the SIP-AS 116 feature server. In this instance, the SIP-AS 116 feature server remains in the call path for the complete call duration. Also, the SIP-AS 116 feature server controls received calls at possible triggering events, e.g., for roaming assistance functionality.

Upon receiving an incoming call, whether originating from the home network or from another network, the SIP-AS 116 feature server determines the subscriber's current registration status. The S-CSCF in CSCF 120 queries the location from the HSS 110 and provides this current registration status information contained in an INVITE to the SIP-AS 116. If the current location of the called party's UE 106 is in the fixed network 100, the call is routed back to the S-CSCF in CSCF 120, processed, and terminated to the UE 106 in the fixed network. Otherwise, the subscriber UE 106 is roaming in the mobile network 102. So, the current location of the UE 106 is not in the fixed network 100.

Accordingly, whenever the UE 106 is roaming in the mobile network 102, the feature server queries the special routing table, and routes the call via the MGCF 124 to the subscriber's GSM HPLMN using the returned Location Routing Number (LRN). For calls routed to the mobile network 102, the INVITE embodies a Request-URI populated in a routing number (rn) field with the LRN, and in a number portability database indicator with yes (npdi=yes). The INVITE message is correspondingly translated in the MGCF 124 into an Integrated Service digital network User Part (ISUP) Initial Address Message (LAM). In particular, a Called Party Number (CdPN) parameter is populated with the ISUP format number converted from the ‘rn’. The Generic Address Parameter (GAP) is populated with the ISUP format number converted from digits immediately following tel Uniform Record Locator (tel URL) in the INVITE. Also, the type of address of the GAP is coded as a “ported number.” Then, the Forward Call Indication (FCI) parameter bit, M, is set to “number translated” to indicate to succeeding switches that a query to the NPDB has been done.

The mobile network 102 may include an International Mobile Subscriber Identity (IMSI) for each of the FMC subscribers, and may be operated by the same or a different operator as the fixed network 100 operator. In particular, the mobile network includes a standard radio access network (RAN) 130, for example, a typical third generation (3G) wireless network. Examples of a suitable 3G wireless network include a typical Universal Mobile Telecommunications System/Code Division Multiple Access UMTS/CDMA network, such as a Global System for Mobile Telecommunication/Enhanced Data-rates for Global Evolution (GSM/EDGE) RAN (GERAN). Further, the RAN 130 must support an appropriate dual mode wireless telephone handset capable of, e.g., Digital Enhanced Cordless Telecommunications (DECT), and mobile connections with roaming, such as a GSM network. Further in this example, a Gateway General Packed Radio Service (GPRS) Support Node (GGSN) 132 couples to the RAN 130 to a next generation core network mobile network extension 134. The next generation core network 134 connects directly to the PSTN/PLMN 104 through a MGW 136, and a Time Division Multiplex (TDM) interface to the PSTN/PLMN 104, for example. FMC calls originating from/terminating to the mobile network 102 connect through MGW 138 to a Distributed Mobile Switching Center (DMSC) 140. The DMSC 140 communicates with the Home Location Register (HLR) 142, which routes FMC calls to the Gateway Mobile Switching Center (GMSC) 144 and out to the PSTN/PLMN 104.

User Equipment (UE) 106 may be any dual mode handset that supports wireless access in the both the fixed network 100 and the mobile network 102 using the same or a different technology, e.g., using Global System for Mobile Telecommunication (GSM) in the mobile network 102 and IEEE 802.11b and/or Bluetooth (WLAN/Bluetooth) in VoIP in the Fixed network 100. A single personal phone number is associated with each UE 106, and can ring the UE 106 both in the cGSM wide area network 130 (which operates normally), and in the fixed network 100 over the broadband 108, e.g., in an ADSL wireline network and home WiFi network. When the UE 106 is in the fixed network 100, incoming calls to the personal number associated with the UE 106 can be answered on UE 106 or, optionally, on single mode cordless WiFi/VoIP phones (not shown) and/or wired VoIP phones (not shown). Thus, users need not carry a respective UE 106 around in the fixed network 100 (e.g., at home) to be able to answer incoming calls to the associated personal number. Also, optionally, a web interface on desktop PC (not shown) may be used to select whether other local phones ring (in the home), on the local handset, the UE 106 or both.

When the UE 106 is registered on the wide area GSM network, calls made to the associated single personal number will only ring on the Dual Mode handset, and not on devices in the home environment. Each UE 106 registers normally with the mobile network 102 (the same as in any state of the art separate mobile network) regardless of current registration status with the fixed network register. A bearer assignment for the mobile network 102 is unnecessary when the UE 106 is located in the fixed network 100. Each UE 106 registers with the fixed network register whenever the subscriber moves the particular into UE 106 the coverage area of the fixed network 100.

So, depending upon reception, each UE 106 is either registered or deregistered with the fixed network register. If registered with the fixed network 100, the UE subscriber is treated as located in the fixed network 100; while if deregistered, the UE subscriber is treated as being out of the fixed network environment. When the UE 106 is moved out of the fixed network coverage area, the UE 106 deregisters with the fixed network 100. Preferably, upon detecting that the signal is weakening, the UE 106 deregisters over the fixed network wireless connection, i.e., WLAN/Bluetooth. Alternately, if deregistration over the fixed network wireless connection is not possible, the UE 106 deregisters over the RAN 130 upon a lost connection to the wireless connection to the fixed network 100. If the UE 106 is unable to deregister (i.e., because the UE 106 has neither wireless fixed network coverage, nor mobile network coverage long enough to deregister), then, the fixed network 100 initiates deregistration after a registration timeout or upon a call delivery failure.

Mobile location management is based on the subscriber's IMSI rather than the subscriber's MSISDN and so, the mobile network 102 handles mobile registration and the mobile location management normally. So, for example, when a FMC subscriber (UE 106) travels to another mobile network, the UE 106 sends a MAP location update to the Visitor Location Register (VLR) in the Visited Public Land Mobile Network (VPLMN). The VPLMN, in turn, authenticates the subscriber and then sends MAP update location to the HLR located in the FMC subscriber's home mobile network (102) for location update.

Terminating calls to FMC subscribers can originate from another FMC subscriber in the fixed network 100, or the mobile network 102, from a non-subscriber in the mobile network 102 or from the PSTN/PLMN 104. (Calls originating from fixed network subscribers already are routed to the fixed network 100, and so, do not require special handling.) Preferably, these FMC terminating calls are always routed to the fixed network 100, which has ownership of a CdPN for each FMC subscriber. For calls originating from the mobile network 102, the Visited Mobile services Switching Center (VMSC) analyzes the CdPN, and identifies any CdPN owned by the fixed network 100. The VMSC routes any call with a FMC CdPN to the fixed network 100. Since the FMC CdPNs are not provisioned in any public NPDB, the VMSC does not need to query the NPDB. Also, because the VMSC treats calls from mobile stations, including UEs 102 as terminating to PSTN/PLMN 104, the VMSC does not need to query the HLR before routing the calls. Calls to UEs 106 that originate from the PSTN/PLMN 104 are treated as normal calls to the fixed network 100, which owns the CdPN. Thus, the originating switch in the PSTN/PLMN 104 analyzes the CdPN, and upon finding that the fixed network 100 owns the number, routes the call to the fixed network 100. It is irrelevant whether the originating switch queries the NPDB, typically, unless it is a true ported number, the CdPN is not provisioned in any public NPDB. Optionally, calls may be routed from a subscriber's primary network to a secondary network regardless of whether the subscriber is available, e.g., when the subscriber UE 106 is in either the fixed network 100 or mobile network 102, but chooses not to answer the call.

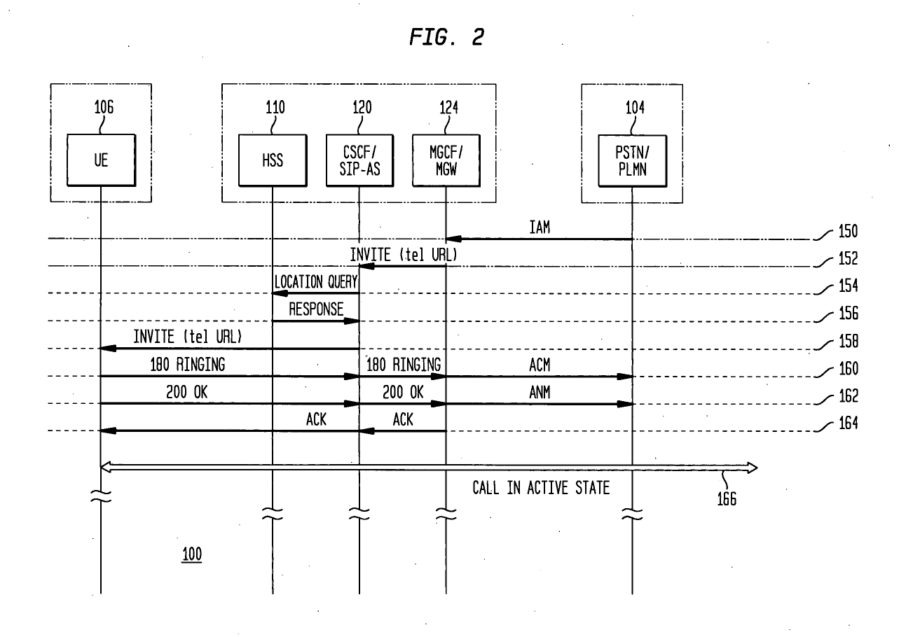

FIG. 2 shows an example of call flow for a call originating from the PSTN/PLMN 104 terminating to a FMC Subscriber in a preferred Home IMS Network, e.g., in fixed network 100 of FIG. 1 with identical features labeled identically. In this example, the P-CSCF, S-CSCF, I-CSCF, and SIP-AS are treated as being in the same platform 118/120. Beginning in 150, a call originating from the PSTN/PLMN 104 and terminating to a preferred FMC UE 106 is routed to the MGW 122 and MGCF 124. Next in 152, the MGCF 124 translates the ISUP IAM into a SIP INVITE. The called number may be translated using a standard telephone numbering plan, e.g., by querying an ENUM server for translating an E.164 number to a SIP URI. The SIP INVITE with translated telephone URI is sent to the CSCF/SIP-AS 116/120. So in 154, upon receiving the SIP INVITE message, the CSCF/SIP-AS 116/120 queries the HSS 110 for the current location information of the FMC subscriber UE 106. The CSCF/SIP-AS 116/120 maps the query (Cx-Location-Query) operation to Diameter commands according to 3GPP standards. In 156 the HSS 110 returns a Location Query Response to the CSCF/SIP-AS 116/120 that indicates whether the FMC subscriber UE 106 is registered and whether an S-CSCF has already been assigned to the UE 106.

Since, in this example, the UE 106 is registered in the fixed network 100, in 158 the CSCF/SIP-AS 116/120 sends a SIP: INVITE to the UE 106 over the fixed network wireless connection, e.g., the WLAN/Bluetooth access network. It should be noted that the CSCF/SIP-AS 116/120 does not simply relay the INVITE from the MGCF 124. Instead, the CSCF/SIP-AS 116/120 sends a new SIP: INVITE to start another session. So, the preferred SIP-AS 120 serves as a Back-To-Back User Agent (B2BUA) and remains in the call path for the complete call duration for better separate control over the call.

The UE 106 responds in 160 by ringing and sending a SIP:180 to the CSCF/SIP-AS 116/120 that indicates that the UE 106 is trying to alert the user. Substantially simultaneously, the CSCF/SIP-AS 116/120 sends a SIP:180 message to the MGCF 124. Upon receiving the SIP:180, the MGCF 124 sends an ISUP Address Complete Message (ACM) to the originating PSTN/PLMN 104. When the FMC subscriber answers the UE 106, the UE 106 responds in 162 by sending a SIP:200OK to the CSCF/SIP-AS 116/120 to indicate the called party has answered the call. The CSCF/SIP-AS 116/120 responds by sending a SIP:200OK to the MGCF 124. Upon receiving the SIP:200OK, the MGCF 124 sends an ISUP Answer Message (ANM) to the originating network, PSTN/PLMN 104. Then in 164, the MGCF 124 acknowledges receipt of the SIP:200OK message by sending a SIP:ACK to the CSCF/SIP-AS 116/120. The CSCF/SIP-AS 116/120 sends a SIP:ACK to the UE 106 and the call is active 166.

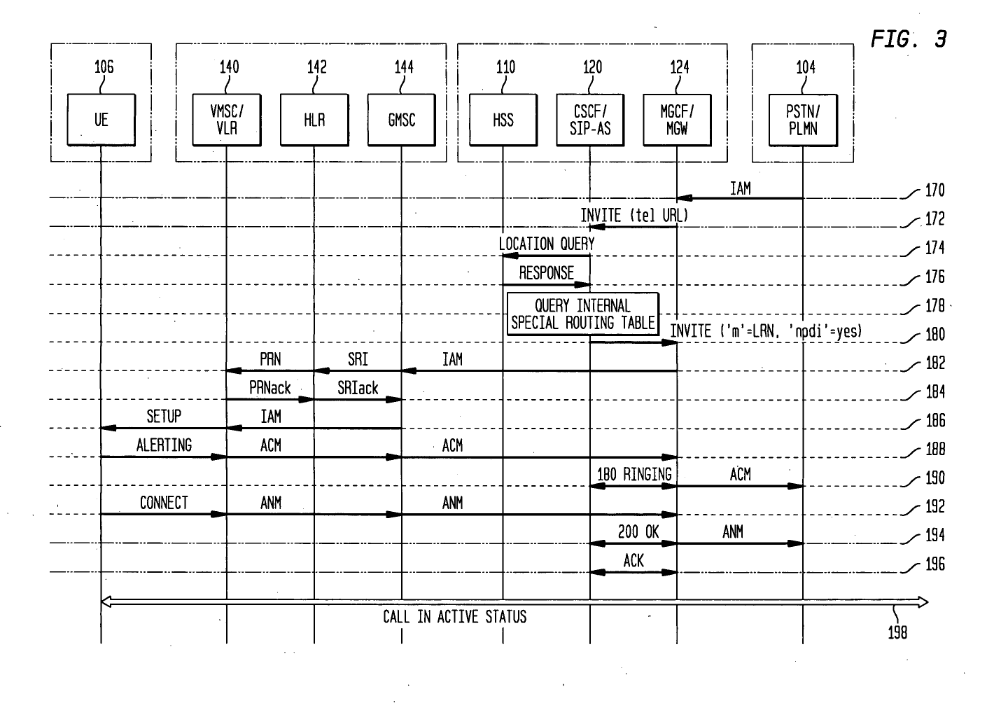

FIG. 3 shows an example of call flow for a MT Call to a FMC Subscriber UE 106, e.g., roaming in the mobile network 100 of FIG. 1 with identical features labeled identically. In this example also, the P-CSCF, S-CSCF, I-CSCF, and SIP-AS are treated as being in the same platform 116/120. Beginning in 170, an FMC terminating call originates from either inside or outside the fixed network 100 associated with the IMS network. The call is routed to the IMS network at the MGCF 122 from PSTN/PLMN 104. Then, in 172 the MGCF 124 translates the ISUP IAM into a SIP INVITE. Again, the called number may be translated using a standard telephone numbering plan. The SIP INVITE with the translated telephone URI is sent to the CSCF/SIP-AS 116/120. Again, upon receiving the SIP INVITE, the CSCF/SIP-AS 116/120 queries the HSS 110 for current location information of the FMC subscriber UE 106 in 174. The Cx-Location-Query operation is mapped to Diameter commands according to 3GPP standards. In 176 the HSS 110 returns a Location Query Response CSCF/SIP-AP 116/120 that indicates that the public identity of the FMC subscriber is not registered.

So, the CSCF/SIP-AP 116/120 queries the internal special routing table in 178, using the CdPN to identify the associated LRN. As a result, the CSCF/SIP-AP 116/120 sends a new SIP:INVITE in 180 to the MGCF 124. The CSCF/SIP-AP 116/120 populates the “rn” field of the Request-URI of the INVITE with the LRN and sets “npdi” to “yes.” As noted hereinabove, the SIP-AS 116 serves as a B2BUA and remains in the call path for the complete call duration to control the call at possible triggering events. So, in 182 the MGCF 124 translates the SIP INVITE as a corresponding ISUP IAM with the CdPN parameter populated with the LRN; with the GAP populated with the CdPN, and the Type of Address of the GAP coded as “ported number”; and, with the FCI parameter bit M set to “number translated” to indicate to succeeding switches that a query to the NPDB has been done. The MGCF 124 subsequently routes the call to the GMSC 144 using the LRN. The GMSC 144 recognizes the CdPN as its own LRN. So, the GMSC 144 treats the IAM the same as any IAM received for any mobile subscriber ported into the GMSC's associated PLMN. Thus, the GMSC 144 sends a MAP Send Routing Info (SRI) using the “ported number” in the GAP to query the HLR 142. The HLR 142 sends a MAP Provide Roaming Number (PRN) to the VLR 140, where the FMC subscriber UE 106 is currently registered. It should also be noted that the VLR 140 may be located in either the FMC mobile network 102 or in some other mobile network. In 184 the VLR 140 returns the Mobile Subscriber Roaming Number (MSRN) in the PRN Ack to the HLR 142. The HLR 142 forwards the MSRN to the GMSC 144 in a SRI Ack. In 186 the GMSC 144 routes the call to the appropriate VMSC using the subscriber's MSRN obtained from the HLR 142 query. The VMSC pages the UE 106 with a Setup message.

The UE 106 responds in 188 by sending an alert to the VMSC. Upon receiving the alert, the VMSC sends an ISUP ACM to the GMSC 144, which the GMSC 144 forwards to the MGCF 124. The MGCF 124 sends a SIP:180 in 190 to the CSCF/SIP-AS 116/120 indicating an attempt to alert the user at UE 106 of the incoming call. The CSCF/SIP-AS 116/120 sends a SIP:180 to the MGCF 124 in the first SIP session. The MGCF 124 further sends an ISUP ACM to the originating PSTN/PLMN 104. When the UE 106 responds in 192, the UE 106 sends a connect message to the CSCF/SIP-AS 116/120 indicating that the called party has answered the call. Also, the VMSC sends an ANM message to the GMSC 144, which is further forwarded to the MGCF 124. The MGCF 124 sends a SIP:200OK to the CSCF/SIP-AP 116/120 in 194 to indicate the request has succeeded. The CSCF/SIP-AS 116/120 sends a SIP:200OK to the MGCF 124 in the first SIP session. Upon receiving the SIP:200OK, the MGCF 124 sends an ISUP ANM to the originating network, the PSTN/PLMN 104 in this example. The MGCF 124 acknowledges the receipt of the SIP:200OK message in 196 by sending a SIP:ACK to the CSCF/SIP-AS 116/120. Also, the CSCF/SIP-AS 116/120 sends a SIP:ACK to the MGCF 124 to acknowledge the receipt of the SIP:200OK message in the first SIP session.

In an alternative preferred embodiment, the mobile network 102 is assigned as the primary home network, while the fixed network 100 is assigned as the secondary home network. In this embodiment, the mobile network 102 owns FMC subscriber numbers, and terminating calls to a FMC subscriber UEs 106 are first routed to the mobile network 102. Then, whenever subscriber UEs 106 are not currently available with the mobile network 102, the mobile network 102 routes FMC subscriber calls to the fixed network 100. For this embodiment, an IN service may populate the LAM message with a LRN with the LRN indicating a switch in the fixed network 100.

Also, it should be noted that application of the present invention is not limited to two networks in a FMC, i.e., a fixed network 100 and mobile network 102. In yet another alternate preferred embodiment, both the primary and secondary home networks are of the same type, i.e., both are fixed, or both are mobile. Further, an LRN may be used that is not associated with Number Portability, but is just a routing number that indicates a particular secondary network and a specific element in a secondary network. In this case, calls from the primary network conveyed to the secondary network can use different conventions than those used for Number Portability.

Advantageously, the present invention has application worldwide to any fixed and/or mobile communications network suitable for Fixed-Mobile Convergence, regardless of type. For example, instead of GSM, the mobile network may be any other suitable type of radio network, such as an ANSI-41 network. Additionally, (Mobile) Network Portability has application wherever the subscriber number is ported to the fixed network from another network. Specifically, (Mobile) Number Portability (MNP) allows subscribers to retain DNs whenever the subscribers change service provider (i.e., service provider portability), location (for location portability), or service (for service portability). In the case where the subscriber number is a “ported in” number, the donor network queries the NPDB and routes the call to the fixed network. In the case where a DN in the subscriber number range is ported out, the call is still routed to the fixed network, as it serves as the donor network. Whenever the fixed network fails to find the registration entry in its register, the fixed network queries the public NPDB, and routes the respective call based on the returned LRN. All of this is without substantially impacting network operation.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A Fixed-Mobile Convergence (FMC) network comprising:
a first communications network;
a second communications network comprising:
a broadband network,
an Internet Protocol (IP) Multimedia (IM) Subsystem (IMS) in an IMS bundle coupled to said broadband network, said IMS including a special routing table with blocks of FMC subscriber numbers, and
wireless data connection capability for wirelessly connecting to said broadband network; and
at least one user device assigned by a single directory number (DN), each said at least one user device wirelessly communicating with both said first communications network and said broadband network identified by said single DN, said single DN being one of said FMC subscriber numbers.

2. A FMC network as in claim 1, wherein said IMS comprises:
a Home Subscriber Server (HSS) maintaining said blocks of FMC subscriber numbers;
a plurality of Application Servers (AS) including a Session Initiation Protocol (SIP) AS (SIP-AS), incoming calls to each said at least one user device being routed to said SIP-AS;
a Call Session Control Function (CSCF), said HSS interfaced to said CSCF, and said each at least one user device interfacing to said CSCF;
a Media Gateway Control Function (MGCF) interfacing said FMC network to a public network; and
a Multimedia Resource Function Processor (MRFP) implementing media-related functions through a Multi-Point SIP (MP SIP) interface to said plurality of application servers and said CSCF.

3. A FMC network as in claim 2, wherein said CSCF comprises:
a Proxy CSCF (P-CSCF) providing a communications network entry point to said each at least one user device;
an Interrogating CSCF (I-CSCF) interfaced to said HSS; and
a Serving CSCF (S-CSCF) providing registration and session control for said each at least one user device.

4. A FMC network as in claim 2, wherein said MGCF comprises:
a signaling gateway interfacing a signaling plane to said public network; and
a media gateway interfacing a media plane to said public network.

5. A FMC network as in claim 1, wherein said first communications network is a cellular communications network and said at least one user device is a dual mode handset including a mobile phone capability for connecting to said cellular communications network and a wireless data connection capability for connecting to said broadband network.

6. A FMC network as in claim 1, wherein said wireless data connection capability is selected from the group comprising Bluetooth and WiFi.

7. A Fixed-Mobile Convergence (FMC) network including at least two communications networks, one of said two communications networks comprising:
one or more user devices, each wirelessly communicating with each communications network in said FMC network in response to a single assigned directly number (DN);
a Home Subscriber Server (HSS) maintaining a special routing table with blocks of FMC subscriber numbers, each said DN being one of said FMC subscriber numbers;
a Session Initiation Protocol (SIP) Application Server (SIP-AS), incoming calls to each user device being routed to said SIP-AS;
a Call Session Control Function (CSCF), said HSS interfaced to said CSCF, and said each user device interfacing to said CSCF; and
a Media Gateway Control Function (MGCF) interfacing said FMC network to a public network.

8. A FMC network as in claim 7, wherein said SIP-AS is one of a plurality of application servers.

9. A FMC network as in claim 8, further comprising a Multimedia Resource Function Processor (MRFP) implementing media-related functions through a Multi-Point SIP (MP SIP) interface to said plurality of application servers and said CSCF.

10. A FMC network as in claim 7, wherein said CSCF comprises:
a Proxy CSCF (P-CSCF) providing a communications network entry point to said each user device;
an Interrogating CSCF (I-CSCF) interfaced to said HSS; and
a Serving CSCF (S-CSCF) providing registration and session control for said each user device.

11. A FMC network as in claim 7, wherein said MGCF comprises:
a signaling gateway interfacing a signaling plane to said public network; and
a media gateway interfacing a media plane to said public network.

12. A FMC network as in claim 7, wherein said one is a fixed network comprising an Internet Protocol (IP) Multimedia (IM) Subsystem (IMS) in an IMS bundle coupled to a broadband network.

13. A FMC network as in claim 12, wherein said each user device wirelessly connects to said broadband network in said fixed network.

14. A FMC network as in claim 13, wherein the other of said two is a mobile communications network and at least one user device is a dual mode handset including a mobile phone capability for connecting to said mobile communications network and a wireless data connection capability for connecting to said broadband network.

15. A FMC network as in claim 14, wherein said wireless data connection capability is selected from the group comprising Bluetooth and WiFi.

16. A method of supporting communications in a converged fixed-mobile network environment in which at least one subscriber user equipment (UE) is assigned a single dialable directory number, said method comprising the steps of:
receiving an incoming call request for said UE in a first network;
verifying the availability said UE in said first network and connecting said incoming call whenever said UE is available in said first network; otherwise
assigning a routing number to said incoming call, said routing number designating said UE in a second network; and
forwarding said incoming call to said UE in said second network.

17. The method of claim 16, wherein said first network is the primary home network of said UE.

18. The method of claim 17, wherein subscriber registration information is maintained with said first network indicating said availability or unavailability of said UE.

19. The method of claim 16, wherein said availability indicates a subscriber preference or UE presence in said first network.

20. The method of claim 16, wherein said unavailability indicates a subscriber preference or UE absence in said first network.

21. The method of claim 16, wherein said single dialable directory number belongs to said first network.

22. The method of claim 16, wherein said first network is a fixed network and said second network is a mobile network.

23. The method of claim 22, wherein said UE accesses said fixed network through a wireless LAN or BlueTooth to a broadband network.

24. The method of claim 22, wherein said UE accesses said wireless network through a protocol selected from the group comprising GSM, UMTS, EDGE, and CDMA.

25. The method of claim 22, wherein said mobile network is the secondary home network of said UE.

26. The method of claim 22, further comprising registering each said UE in an HLR of said mobile network and in an HSS of said fixed network.

27. The method of claim 26, wherein said UE is assigned an IMSI and/or MIN belonging to said mobile network.

28. The method of claim 16, wherein said routing number is a Location Routing Number for Number Portability.

29. The method of claim 28, wherein the step of forwarding of said incoming call to said UE in said second network further comprises:
employing said Location Routing Number as a Called Party Number; and
conveying said single dialable directory number in said call forwarding.

30. The method of claim 29, wherein said conveying step conveys using conventions defined for Number Portability.

31. The method of claim 30, wherein said conventions employ an ISUP Generic Address Parameter.

32. The method of claim 30, wherein said UE in said second network treats each said forwarded said incoming call the same, according to the requirements of Number Portability, as an incoming call for a mobile station with a number ported into said second network.

33. The method of claim 16, further comprising:
verifying the presence of said UE in said second network; and
forwarding said call to said UE in said second network.

34. The method of claim 16, further comprising:
verifying the presence of said UE in a third network; and
forwarding said call to said UE in said third network.

35. The method of claim 34, wherein said first network is a fixed network, said second network is a first mobile network and said third network is a second mobile network distinct from said first mobile network.

36. The method of claim 24, wherein said single dialable directory number is treated as the mobile network number of said UE.

37. The method of claim 23, wherein said verifying and/or said forwarding use a SIP.

37. The method of claim 23, wherein said verifying and/or said forwarding use a Diameter protocol interface.

38. The method of claim 16, wherein said first network is a mobile network and said second network is a fixed network.

39. The method of claim 38, wherein said UE accesses said mobile network through a protocol selected from the group comprising GSM, UMTS, EDGE, and CDMA.

40. The method of claim 38, wherein said subscriber accesses said fixed network through a wireless connection to broadband, said wireless connection being one of a wireless LAN and a BlueTooth connection.

41. The method of claim 16, wherein said first network is a first fixed network and said second network is a second fixed network distinct from said first fixed network.

42. The method of claim 16, wherein said first network is a first mobile network and said second network is a second mobile network distinct from said first mobile network.

43. The method of claim 16, wherein said incoming call is originated from outside said first network.

44. The method of claim 16, wherein said incoming call is originated in said first network.

45. The method of claim 29, wherein conveying said incoming call uses Number Portability.

46. The method of claim 16, wherein said single dialable directory number is a ported number.
